(19) United States
(12) Patent Application Publication
(10) Pub. No.: US 2016/0099006 A1
(43) Pub. Date: Apr. 7, 2016

(54) ELECTRONIC DEVICE, METHOD, AND COMPUTER PROGRAM PRODUCT

(71) Applicant: Kabushiki Kaisha Toshiba, Tokyo (JP)

(72) Inventors: Takehiko ISAKA, Hachioji Tokyo (JP); Kimio MISEKI, Ome Tokyo (JP)

(21) Appl. No.: 14/734,716

(22) Filed: Jun. 9, 2015

(30) Foreign Application Priority Data
Oct. 1, 2014 (JP) 2014-203402

(51) Int. Cl. G10L 21/0208; G10L 21/043

(52) U.S. Cl. CPC G10L 21/0208; G10L 21/043

(57) ABSTRACT

According to one embodiment, an electronic device includes circuitry configured to perform a process for suppressing a noise of a sound signal by a first suppression amount when a first reproduction speed of the sound signal is set to a first value by user, wherein the circuitry is configured to perform a process for suppressing a noise of a sound signal by a second suppression amount larger than the first suppression amount when a second reproduction speed of the sound signal is set to a second value lower than the first value by a user, and the circuitry is configured to reproduce a noise-suppressed sound signal in accordance with the first reproduction speed or the second reproduction speed set by a user.

### CROSS-REFERENCE TO RELATED APPLICATIONS

This application is based upon and claims the benefit of priority from Japanese Patent Application No. 2014-203402, filed Oct. 1, 2014, the entire contents of which are incorporated herein by reference.

### FIELD

Embodiments described herein relate generally to an electronic device, a method, and a computer program product.

### BACKGROUND

There has been a technique of recording sounds such as voice sounds during a meeting, a lecture, or the like, and converting a speech speed (speed of utterance) in reviewing the contents of the meeting, the lecture, or the like by listening to the recorded voice sounds.

However, when speech speed conversion is performed with respect to a voice sound to elongate a pitch of the voice sound; that is, a fundamental period of the voice sound, there exists the case that the phase of the background noise included in the voice sound is distorted and the sound quality of the voice sound is deteriorated. Hence, the improvement of the technique of converting a speech speed is required.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view illustrating one example of an appearance of a tablet terminal to which an electronic device according to an embodiment is applied;

FIG. 2 is an exemplary view illustrating one example of a hardware configuration of the tablet terminal in the present embodiment;

FIG. 3 is an exemplary view illustrating one example of a software configuration of the tablet terminal achieved in the present embodiment;

FIG. 4 is an exemplary flowchart illustrating the flow of speech-speed conversion processing of an input voice signal in the tablet terminal in the present embodiment; and

FIG. 5 is an exemplary view illustrating one example of a waveform spectrum of the input voice signal subjected to noise suppression processing performed by the tablet terminal in the present embodiment.

### DETAILED DESCRIPTION

In general, according to one embodiment, an electronic device comprises: circuitry configured to perform a process for suppressing a noise of a sound signal by a first suppression amount when a first reproduction speed of the sound signal is set to a first value by user, wherein the circuitry is configured to perform a process for suppressing a noise of a sound signal by a second suppression amount larger than the first suppression amount when a second reproduction speed of the sound signal is set to a second value lower than the first value by a user, and the circuitry is configured to reproduce a noise—suppressed sound signal in accordance with the first reproduction speed or the second reproduction speed set by a user.

Hereinafter, in conjunction with attached drawings, an explanation is made with respect to an electronic device, a method, and a computer program product according to embodiments.

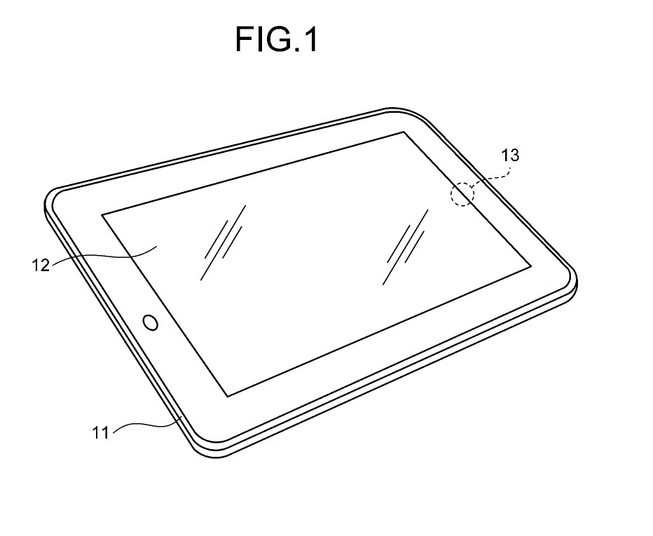

FIG. 1 is a view illustrating one example of an appearance of a tablet terminal to which the electronic device according to an embodiment is applied. In the present embodiment, although the explanation is made with respect to an example that applies the electronic device to the tablet terminal, the present embodiment is not limited to this example. For example, it is also possible to apply the electronic device to a smart phone, a mobile phone, a personal digital assistant (PDA), a notebook type personal computer, a digital television, or the like. In the present embodiment, as illustrated in FIG. 1, the tablet terminal is provided with a body 11, a display 12, and a camera module 13.

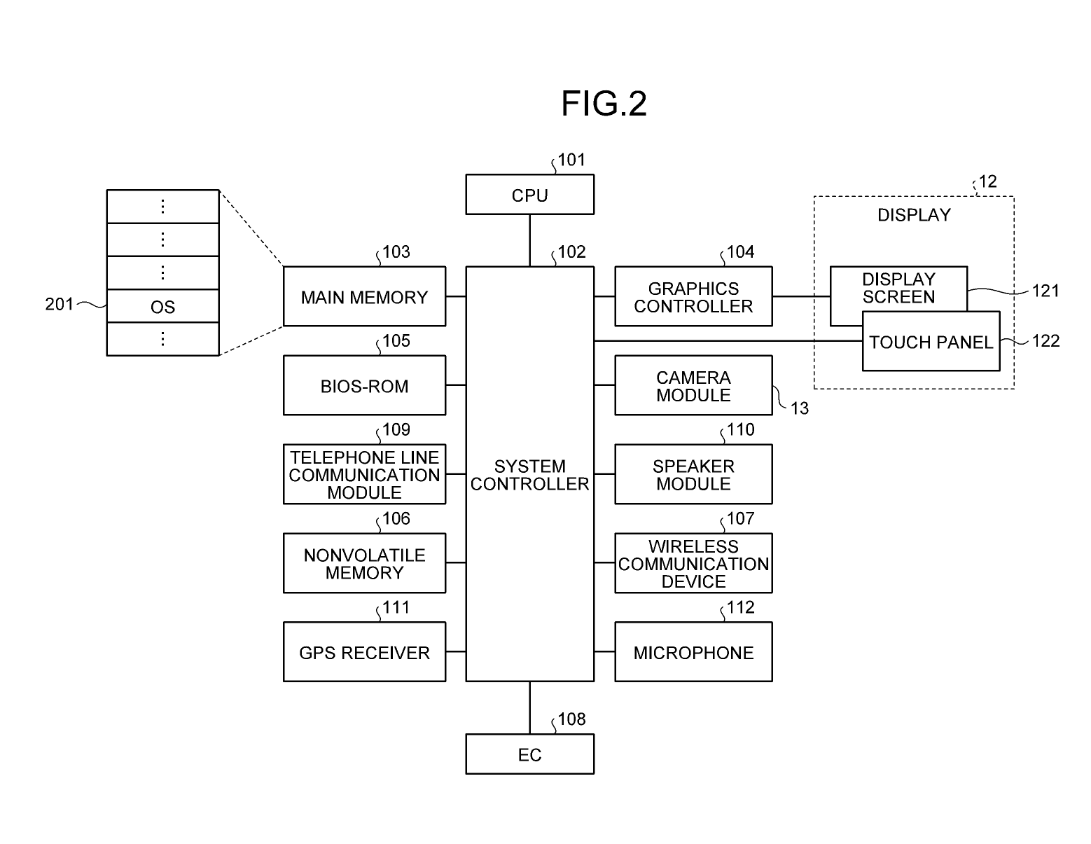

The body 11 comprises a housing formed in a flat rectangular parallelepiped box shape. The display 12 is a touch panel display comprising a display screen 121 (see FIG. 2) constituted of a liquid crystal display (LCD) or the like, and a touch panel 122 (see FIG. 2) that is constituted of an electrostatic capacitance-type touch panel, an electromagnetic induction-type digitizer, or the like, and is capable of detecting a touch operation (tap) performed with a stylus pen, a finger, or the like on the display screen 121. The camera module 13 is an image pick-up module provided to the body 11 in such a manner that the image pick-up module is capable of picking up an image in front of a surface opposite to a surface on which the display screen 121 is arranged toward the outside of the body 11.

FIG. 2 is a view illustrating one example of a hardware configuration of the tablet terminal in the present embodiment. The tablet terminal according to the present embodiment comprises, as illustrated in FIG. 2, a central processing unit (CPU) 101, a system controller 102, a main memory 103, a graphics controller 104, a basic input/output system (BIOS) read only memory (ROM) 105, a nonvolatile memory 106, a wireless communication device 107, an embedded controller (EC) 108, a telephone line communication module 109, a speaker module 110, a global positioning system (GPS) receiver 111, and a microphone 112.

The CPU 101 is one example of a processor (computer) that functions as a controller for controlling the operation of each module in the tablet terminal, and is mounted on an electronic circuit. To be more specific, the CPU 101 executes a BIOS stored in the BIOS-ROM 105. Thereafter, the CPU 101 executes various kinds of programs loaded into the main memory 103 from the nonvolatile memory 106 that is one example of a storage device. As the computer programs executed by the CPU 101 include various kinds of application programs such as an operating system (OS) 201.

The system controller 102 is a device that connects between a local bus of the CPU 101 and each of various kinds of modules. The system controller 102 also comprises a memory controller that controls access to the main memory 103. Furthermore, the system controller 102 has a function for communicating with the graphics controller 104 via a serial bus or the like compliant with the PCI EXPRESS standard.

The graphics controller 104 functions as a display controller that controls the display 12. To be more specific, the graphics controller 104 generates, when displaying various kinds of information on the display 12, a display signal for displaying the various kinds of information. And the graphic controller 104 outputs the display signal to the display screen 121 thus displaying the various kinds of information on the display screen 121.

The wireless communication device 107 is a device that performs wireless communications with an external instrument by a wireless local area network (LAN), Bluetooth (registered trademark), or the like. The embedded controller 108 turns on or turns off the power of the tablet terminal.

The camera module 13 is, as described above, an image pick-up module provided to the body 11 in such a manner that the image pick-up module is capable of picking up an image in front of a surface opposite to a surface on which the display screen 121 is arranged. In the present embodiment, the camera module 13 picks up an image of the circumference of the tablet terminal when a touch operation performed by a user is detected by the touch panel 122. The touch operation is an operation being performed with respect to a button displayed on the display screen 121.

The speaker module 110 outputs sounds such as voice sounds based on sound signals input from the CPU 101 via the system controller 102. The microphone 112 is arranged in such a manner that the microphone 112 is capable of collecting sounds around the tablet terminal. Furthermore, the microphone 112 stores the signals of sounds such as collected voice sounds (hereinafter, referred to as “input voice sound signal”) in the main memory 103.

The telephone line communication module 109 is a module for performing data communications with an external instrument via a base station by using a mobile communication system such as “3G”. The GPS receiver 111 receives positional information of the tablet terminal measured by the GPS.

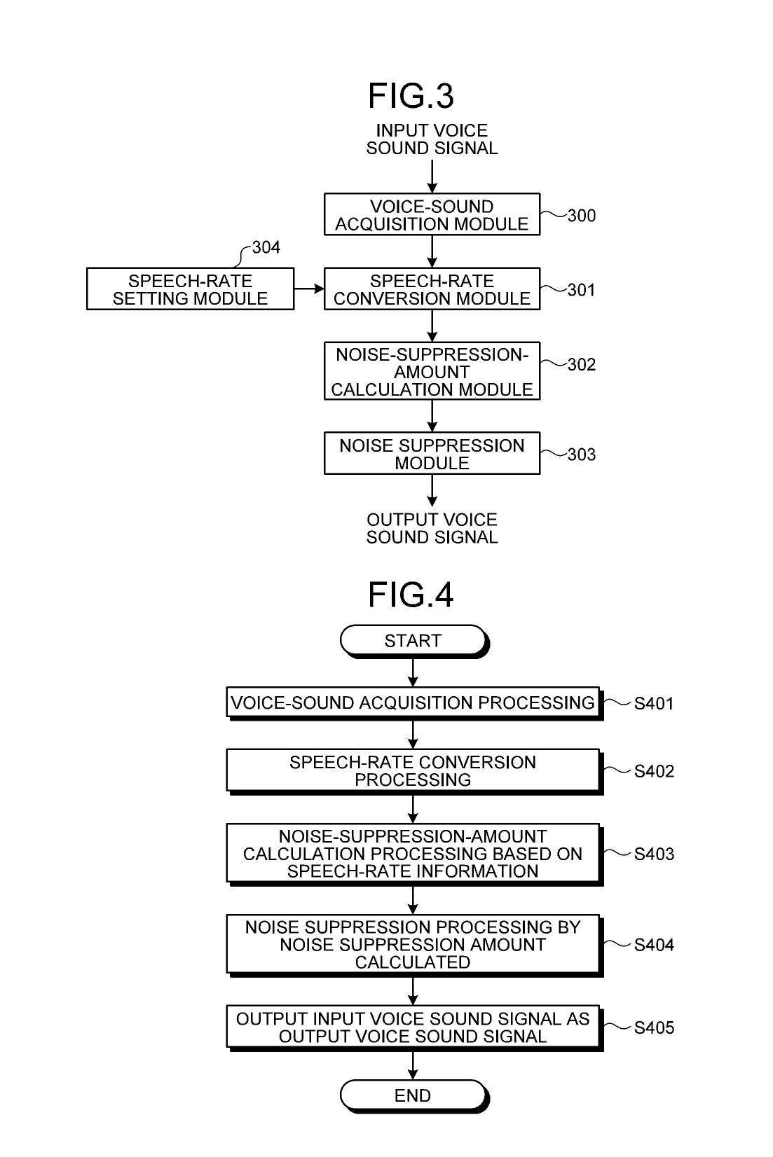

FIG. 3 is a view illustrating one example of a software configuration of the tablet terminal achieved in the present embodiment. In the present embodiment, as illustrated in FIG. 3, the CPU 101 executes various kinds of programs stored in the main memory 201 and hence, a voice-sound acquisition module 300, a speech-speed conversion module 301, a noise-suppression-amount calculation module 302, a noise suppression module 303, and a speech-speed setting module 304 are achieved.

The voice-sound acquisition module 300 acquires, when the output of an input voice sound signal is instructed in response to the touch operation detected by the touch panel 122, the input voice sound signal stored in the nonvolatile memory 106. The speech-speed setting module 304 sets, in accordance with the touch operation detected by the touch panel 122, speech-speed information that is information with respect to a speech speed (one example of a speed set by a user) which is a reproduction speed of the input voice sound signal acquired by the voice-sound acquisition module 300. In the present embodiment, the speech-speed setting module 304 sets information indicating the multiplying factor of a speech speed of an input voice sound signal after processing for reproduction (hereinafter, referred to as “speech-speed conversion processing”) is performed to a speech speed of an input voice sound signal before the speech-speed conversion processing is performed, as speech speed information. Furthermore, the speech speed (a reproduction speed of an input voice sound signal) set by the user may be any information provided that the speech speed information is information used for determining the reproduction speed for the reproduction of the input voice sound signal. For example, the speech speed information may be a parameter indicating the reproduction speed of the input voice sound signal by a multiplying factor, or a parameter indicating the reproduction speed of the input voice sound signal by a fundamental period (pitch) of a signal included in the input voice sound signal (in particular, voice sound uttered by a user).

In the present embodiment, the speech-speed setting module 304 sets the multiplying factor of a speech speed of an input voice sound signal after the speech-speed conversion processing is performed to a speech speed of an input voice sound signal before the speech-speed conversion processing is performed, as the speech speed information. However, the speech speed information is not limit to this example provided that information with respect to the speech speed of the input voice sound signal after the speech-speed conversion processing is performed is set as the speech speed information. For example, the speech-speed setting module 304 may set the information indicating the speech speed of the input voice sound signal after the speech-speed conversion processing is performed, as the speech speed information.

The speech-speed conversion module 301 performs the speech-speed conversion processing that converts the speech speed of the input voice sound signal acquired by the voice-sound acquisition module 300 depending on the speech speed information set by the speech-speed setting module 304 in advance. The noise-suppression-amount calculation module 302 performs noise-suppression-amount calculation processing that calculates the amount of suppressing noise included in the input voice sound signal (hereinafter, referred to as “a noise suppression amount ”). The noise suppression module 303 performs noise suppression processing that suppresses the noise included in the input voice sound signal by the noise suppression amount calculated by the noise-suppression-amount calculation module 302. In the present embodiment, the tablet terminal performs, as illustrated in FIG. 3, the speech-speed conversion processing by the speech-speed conversion module 301, the noise-suppression-amount calculation processing by the noise-suppression-amount calculation module 302, and the noise suppression processing by the noise suppression module 303, in the order given above. However, the present embodiment is not limited to this example. For example, the tablet terminal may perform each processing in order of the noise-suppression-amount calculation processing by the noise-suppression-amount calculation module 302, the speech-speed conversion processing by the speech-speed conversion module 301, and the noise suppression processing by the noise suppression module 303. The tablet terminal may also perform each processing in order of the noise-suppression-amount calculation processing by the noise-suppression-amount calculation module 302, the noise suppression processing by the noise suppression module 303, and the speech-speed conversion processing by the speech-speed conversion module 301.

Next, in conjunction with FIG. 4, the explanation is made with respect to the flow of the speech-speed conversion processing of the input voice sound signal in the tablet terminal according to the present embodiment. FIG. 4 is a flowchart illustrating the flow of the speech-speed conversion processing of the input voice sound signal in the tablet terminal in the present embodiment.

The voice-sound acquisition module 300 performs, when the reproduction of an input voice sound signal is instructed in response to the touch operation detected by the touch panel 122, voice-sound acquisition processing that acquires the input voice sound signal from the nonvolatile memory 106 (S401). In the present embodiment, although the voice-sound acquisition module 300 acquires the input voice sound signal stored in the nonvolatile memory 106 as one example of the signal of a sound to be reproduced, the present embodiment is not limited to this example. The voice-sound acquisition module 300 may acquire the signal of a sound stored in an external instrument such as a server as the signal of a sound to be reproduced.

The speech-speed conversion module 301 performs, when the input voice sound signal is acquired by the voice-sound acquisition module 300, speech-speed conversion processing that converts the speech speed of the input voice sound signal acquired in accordance with speech speed information set in advance by the speech-speed setting module 304 (S402). In that case, the speech-speed conversion module 301 decreases the speech speed of the acquired input voice sound signal, or increases the speech speed of the acquired input voice sound signal by using the fundamental period of a voice sound thereby performing the speech-speed conversion processing. To be more specific, the speech-speed conversion module 301 elongates or contracts the fundamental period (pitch) of the voice sound included in the acquired input voice sound signal thereby performing the speech-speed conversion processing that converts the speech speed of the acquired input voice sound signal. In the present embodiment, as one example of the signal of a sound to be reproduced, the input voice sound signal that is a signal of a voice sound is acquired and hence, the speech-speed conversion module 301 performs the speech-speed conversion processing of the input voice sound signal acquired by using the fundamental period of a voice sound. However, when the signal of a sound to be reproduced is the signal of a sound other than a human voice, the sound having a predetermined fundamental period, the speech-speed conversion module 301 performs the speech-speed conversion processing of the signal of the sound to be reproduced by using the fundamental period of the sound.

In the present embodiment, the speech speed setting module 304 displays a graphic user interface (GUI) for setting speech speed information on the display screen 121 in advance of the speech-speed conversion processing of the input voice sound signal. Furthermore, the speech speed setting module 304 sets the speech speed information in response to a touch operation with respect to the GUI, the touch operation being detected by the touch panel 122.

The noise-suppression-amount calculation module 302 performs, when the speech speed of the input voice sound signal is converted by the speech-speed conversion module 301, the noise-suppression-amount calculation processing that calculates the noise suppression amount of noise included in the input voice sound signal based on the speech speed of the input voice sound signal after the speech-speed conversion processing is performed (S403). To be more specific, when the speech-speed setting module 304 sets the speech speed information with respect to a first speech speed; that is, when the speech-speed conversion module 301 converts the pitch of a voice sound included in the input voice sound signal into a first pitch, the noise-suppression-amount calculation module 302 calculates a first noise suppression amount (one example of a first suppression amount). On the other hand, when the speech-speed setting module 304 sets speech speed information with respect to a second speech speed lower than the first speech speed; that is, when the speech-speed setting module 304 converts the speech speed of the input voice sound signal into the second speech speed slower than the first speech speed, or when the speech-speed conversion module 301 converts the pitch of the voice sound included in the input voice sound signal into a second pitch longer than the first pitch, the noise-suppression-amount calculation module 302 calculates a second noise suppression amount (one example of a second suppression amount) larger than the first noise suppression amount.

For example, the noise-suppression-amount calculation module 302 calculates 8 dB as the first noise suppression amount when the speech speed information with respect to the first speech speed that is 0.5 time the speech speed of the input voice sound signal before the speech-speed conversion processing is performed is set. On the other hand, the noise-suppression-amount calculation module 302 calculates 10 dB as the second noise suppression amount when the speech speed information with respect to the second speech speed that is equal to or lower than 0.5 time the speech speed of the input voice sound signal before the speech-speed conversion processing is performed is set.

The noise suppression module 303 uses a spectral subtraction method or the like to perform the noise suppression processing that suppresses noise included in the input voice sound signal after the speech-speed conversion processing is performed by the noise suppression amount calculated by the noise-suppression-amount calculation module 302 (S404). To be more specific, when the speech speed information with respect to the first speech speed (a speech speed that is higher than 0.5 time the speech speed of the input voice sound signal after the speech-speed conversion processing is performed in the present embodiment) is set, the noise suppression module 303 suppresses the noise included in the input voice sound signal whose speech speed is converted into the first speech speed by the first noise suppression amount. On the other hand, when the speech speed of the input voice sound signal is converted into the second speech speed (a speech speed that is equal to or lower than 0.5 time the speech speed of the input voice sound signal after the speech-speed conversion processing is performed in the present embodiment) lower than the first speech speed, the noise suppression module 303 suppresses the noise included in the input voice sound signal whose speech speed is converted into the second speech speed by the second noise suppression amount. Furthermore, the noise suppression module 303 outputs the input voice sound signal after the noise suppression processing is performed to the speaker module 110 as an output voice sound signal (S405). In the present embodiment, the tablet terminal performs, as illustrated in FIG. 4, the speech-speed conversion processing by the speech-speed conversion module 301 (S402), the noise-suppression-amount calculation processing by the noise-suppression-amount calculation module 302 (S403), and the noise suppression processing by the noise suppression module 303 (S404), in the order given above. However, the present embodiment is not limited to this example. For example, the tablet terminal may perform each processing in order of the noise-suppression-amount calculation processing by the noise-suppression-amount calculation module 302 (S403), the speech-speed conversion processing by the speech-speed conversion module 301 (S402), and the noise suppression processing by the noise suppression module 303 (S404). The tablet terminal may also perform each processing in order of the noise-suppression-amount calculation processing by the noise-suppression-amount calculation module 302 (S403), the noise suppression processing by the noise suppression module 303 (S404), and the speech-speed conversion processing by the speech-speed conversion module 301 (S402).

Accordingly, when the speech speed of an input voice sound signal is converted into the second speech speed and the phase of the noise included in the input voice sound signal is distorted, the deterioration of the sound quality of the input voice sound signal can be prevented even without recovering the input voice sound signal from the distortion of the phase thereof. Hence, when the speech speed of the input voice sound signal is converted into the second speech speed, the input voice sound signal of a desired speech speed can be output.

In the present embodiment, when the speech speed of the input voice sound signal is converted into the second speech speed that is equal to or lower than 0.5 time the speech speed of the input voice sound signal before the speech-speed conversion processing is performed, the noise suppression module 303 suppresses noise included in the input voice sound signal whose speech speed is converted into the second speech speed by the second noise suppression amount. However, when the speech speed of an input voice sound signal is converted into the second speech speed lower than the speech speed of an input voice sound signal before the speech-speed conversion processing is performed, the noise suppression module 303 may suppress the noise included in the input voice sound signal whose speech speed is converted into the second speech speed by the second noise suppression amount.

In the present embodiment also, when the speech speed of an input voice sound signal is converted into a third speech speed that is faster than the first speech speed, the noise suppression module 303 suppresses noise in the input voice sound signal whose speech speed is converted into the third speech speed on the basis of the first noise suppression amount by a variation (third suppression amount) that is smaller than the difference between the first noise suppression amount and the second noise suppression amount. Alternatively, the noise suppression module 303 restricts, when the speech speed of the input voice sound signal is converted into the third speech speed, the suppression of the noise included in the input voice sound signal whose speech speed is converted into the third speech speed; that is, the noise included in the input voice sound signal whose speech speed is converted into the third speech speed is not suppressed. Accordingly, when the speech speed of the input voice sound signal is converted into the third speech speed, unnecessary noise suppression can be prevented in the case that sound quality is not deteriorated by the distortion of the noise included in the input voice sound signal due to the speech-speed conversion processing.

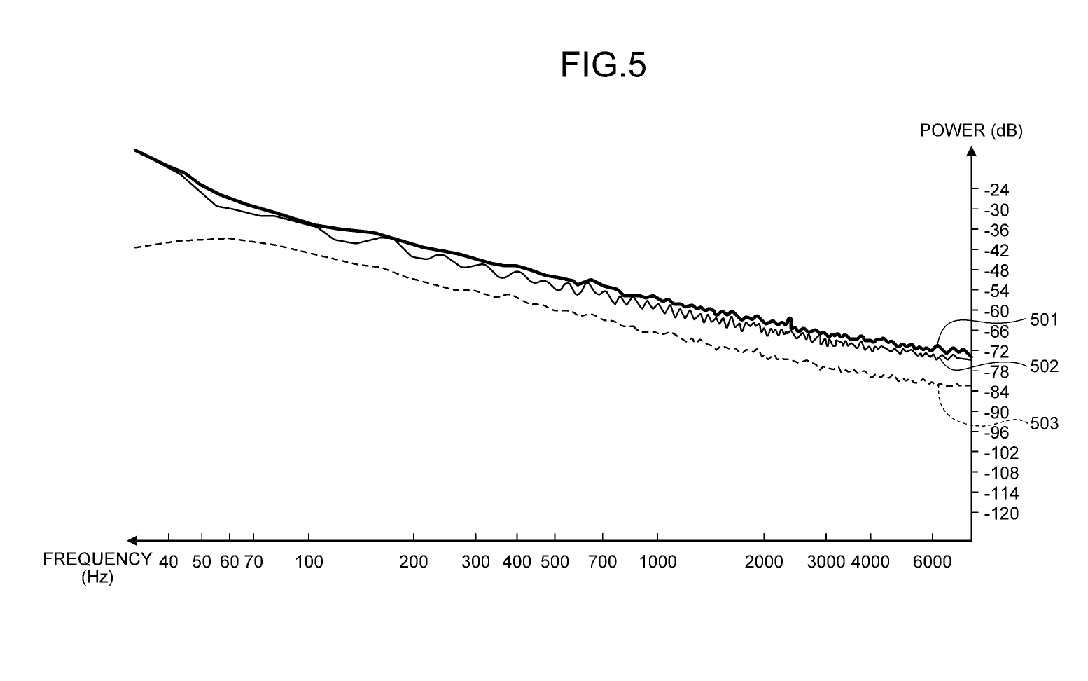

FIG. 5 is a view illustrating one example of a waveform spectrum of the input voice signal subjected to the noise suppression processing performed by the tablet terminal in the present embodiment. In the waveform spectrum of an input voice sound signal illustrated in FIG. 5, the waveform power of the input voice sound signal is taken on an axis of ordinate, and the frequency of the input voice sound signal is taken on an axis of abscissas. In FIG. 5, a first spectrum 501 is the spectrum of the input voice sound signal before speech-speed conversion processing is performed. In FIG. 5 also, a second spectrum 502 is the spectrum of the input voice sound signal whose speech speed is converted into the second speech speed (the speech speed that is 0.5 time the speech speed of the input voice sound signal before the speech-speed conversion processing is performed) and noise is not suppressed. In FIG. 5 also, a third spectrum 503 is the spectrum of the input voice sound signal whose speech speed is converted into the second speech speed and noise is suppressed by the second noise suppression amount (8 dB, for example).

As illustrated in FIG. 5, the second spectrum 502 has irregularities as compared with the first spectrum 501, and deteriorates in sound quality. On the other hand, the third spectrum 503 is smoothed in irregularities as compared with the second spectrum 502, and reduced in sound quality deterioration.

In this manner, according to the tablet terminal of the present embodiment, when the speech speed of the input voice sound signal is converted into the second speech speed, the input voice sound signal of a desired speech speed can be output while preventing the deterioration of sound quality of the input voice sound signal.

In the present embodiment, when the speech speed of the input voice sound signal is converted into a speech speed that is equal to or lower than 0.5 time the speech speed of the input voice sound signal before the speech-speed conversion processing is performed, the noise suppression module 303 suppresses noise included in the input voice sound signal by the second noise suppression amount. However, even when the speech speed of the input voice sound signal is converted into a speech speed that is equal to or lower than 0.5±0.1 time the speech speed of the input voice sound signal before the speech-speed conversion processing is performed, the noise included in the input voice sound signal is suppressed by the second noise suppression amount, thus outputting an input voice sound signal of a desired speech speed in the same manner as the case that the speech speed of the input voice sound signal is converted into a speech speed that is equal to or lower than 0.5 time the speech speed of the input voice sound signal before the speech-speed conversion processing is performed, while preventing the deterioration of the sound quality of the input voice sound signal.

A computer program executed in the tablet terminal according to the present embodiment is provided in the form of a ROM or the like in which the computer program is embedded in advance. The computer program executed in the tablet terminal in the present embodiments maybe provided in the form of the storage medium capable of being read by the computer; that is, a compact disc read only memory (CD-ROM), a flexible disk (FD), a compact disc recordable (CD-R), a digital versatile disc (DVD), or the like in which the computer program is stored in an installable or executable file.

The computer program executed in the tablet terminal in the present embodiment may be stored in a computer connected to a network such as the Internet and provided by being downloaded via the network. Furthermore, the computer program executed in the tablet terminal in the present embodiment may be provided or distributed via a network such as the Internet.

The computer program executed in the tablet terminal in the present embodiments is constituted of modules including the above-mentioned respective modules (the voice-sound acquisition module 300, the speech-speed conversion module 301, the noise-suppression-amount calculation module 302, the noise suppression module 303, and the speech-speed setting module 304). As actual hardware, the CPU 101 reads out the computer program from the above-mentioned ROM to execute the computer program, and thus the above-mentioned respective modules are loaded on a main memory, and the voice-sound acquisition module 300, the speech-speed conversion module 301, the noise-suppression-amount calculation module 302, the noise suppression module 303, and the speech-speed setting module 304 are generated on the main memory.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
circuitry configured to:
perform a process for suppressing a noise of a sound signal by a first suppression amount when a first reproduction speed of the sound signal is set to a first value by user;
perform a process for suppressing a noise of a sound signal by a second suppression amount larger than the first suppression amount when a second reproduction speed of the sound signal is set to a second value lower than the first value by a user; and
reproduce a noise-suppressed sound signal in accordance with the first reproduction speed or the second reproduction speed set by a user.

2. The electronic device of claim 1, wherein the sound signal is a human voice signal.

3. The electronic device of claim 1, wherein the second reproduction speed is slower than the speed of the sound signal before the processing for reproducing the sound signal is executed.

4. The electronic device of claim 1, wherein upon setting of a third reproduction speed faster than the first reproduction speed, the sound signal is reproduced at the third reproduction speed after suppressing noise in the sound signal by a third suppression amount smaller than a difference between the first suppression amount and the second suppression amount.

5. The electronic device of claim 3, wherein the second reproduction speed is equal to or lower than 0.6 times the speed of the sound signal before the processing for reproducing the sound signal is executed.

6. A method of executing processing for reproducing a sound signal depending on a speed set by a user, the method comprising:
performing a process for suppressing a noise of a sound signal by a first suppression amount when a first reproduction speed of the sound signal is set to a first value by user;
performing a process for suppressing a noise of a sound signal by a second suppression amount larger than the first suppression amount when a second reproduction speed of the sound signal is set to a second value lower than the first value by a user; and
reproducing a noise-suppressed sound signal in accordance with the first reproduction speed or the second reproduction speed set by a user.

7. The method of claim 6, wherein the sound signal is a human voice signal.

8. The method of claim 6, wherein the second reproduction speed is slower than the speed of the sound signal before the processing for reproducing the sound signal is executed.

9. The method of claim 6, the method comprising:
upon setting of a third reproduction speed faster than the first reproduction speed, reproducing the sound signal at the third reproduction speed after suppressing noise in the sound signal by a third suppression amount smaller than a difference between the first suppression amount and the second suppression amount.

10. The method of claim 8, wherein the second reproduction speed is equal to or lower than 0.6 times the speed of the sound signal before the processing for reproducing the sound signal is executed.

11. A computer program product having a non-transitory computer readable medium including programmed instructions wherein the instructions, when executed by a computer, cause the computer to perform:
reproducing a sound signal depending on a speed set by a user;
performing a process for suppressing a noise of a sound signal by a first suppression amount when a first reproduction speed of the sound signal is set to a first value by user;
performing a process for suppressing a noise of a sound signal by a second suppression amount larger than the first suppression amount when a second reproduction speed of the sound signal is set to a second value lower than the first value by a user; and
reproducing a noise-suppressed sound signal in accordance with the first reproduction speed or the second reproduction speed set by a user.

12. The computer program product of claim 11, wherein the sound signal is a human voice signal.

13. The computer program product of claim 11, wherein the second reproduction speed is slower than the speed of the sound signal before the processing for reproducing the sound signal is executed.

14. The computer program product of claim 11, wherein the instructions further cause the computer to perform
upon setting of a third reproduction speed faster than the first reproduction speed, reproducing the sound signal at the third reproduction speed after suppressing noise in the sound signal by a third suppression amount smaller than a difference between the first suppression amount and the second suppression amount.

15. The computer program product of claim 13, wherein the second reproduction speed is equal to or lower than 0.6 times the speed of the sound signal before the processing for reproducing the sound signal is executed.
